(19) United States
(12) Patent Application Publication
(10) Pub. No.: US 2024/0123545 A1
(43) Pub. Date: Apr. 18, 2024

(54) METHOD AND APPARATUS FOR GENERATING A WELDING CONTOUR WITH MULTIPLE LASER SPOTS BY WAY OF A SCANNER OPTICAL UNIT

(71) Applicant: TRUMPF Laser- und Systemtechnik GmbH, Ditzingen (DE)

(72) Inventors: Patrick HAUG, Gerlingen (DE); Philipp SCHEIBLE, Ditzingen (DE); Nicolai SPEKER, Pleidelsheim (DE); Tim HESSE, Ditzingen (DE)

(21) Appl. No.: 18/391,699

(22) Filed: Dec. 21, 2023

Related U.S. Application Data
(63) Continuation of application No. PCT/EP2022/066903, filed on Jun. 21, 2022.

(30) Foreign Application Priority Data
Jun. 23, 2021 (DE) 10 2021 206 490.6

(51) Int. Cl. B23K 26/082; B23K 26/03; B23K 26/06; B23K 26/067; B23K 26/28

(52) U.S. Cl. CPC B23K 26/082; B23K 26/032; B23K 26/0643; B23K 26/0676; B23K 26/28; B23K 2103/10

(57) ABSTRACT

A method for welding at least two aluminum-containing components is provided. Each component has a content of at least 75% by weight of aluminium. The method includes subdividing an output laser beam into multiple partial beams directed onto the components such that multiple laser spots are generated on a surface of the components, and traversing a welding contour on the surface of the components with the multiple laser spots. Laser spot centers of at least three laser spots of the multiple laser spots are arranged in a ring formation. The output laser beam is generated by a multifiber such that each laser spot of the multiple laser spots on the surface of the components has a core portion and a ring portion. The welding contour is at least partially traversed by pivoting a first mirror in a controlled manner by a scanner optical unit.

### CROSS REFERENCE TO RELATED APPLICATIONS

This application is a continuation of International Application No. PCT/EP2022/066903 (WO 2022/268822 A1), filed on Jun. 21, 2022, and claims benefit to German Patent Application No. DE 10 2021 206 490.6, filed on Jun. 23, 2021. The aforementioned applications are hereby incorporated by reference herein.

### FIELD

Embodiments of the present invention relate to a method for welding at least two aluminum-containing components.

Embodiments of the invention also relate to a component arrangement produced by the method and to an apparatus for welding components.

### BACKGROUND

In the field of electromobility, for numerous usage situations it is necessary to join components which are impermeable to various media. Typical media with respect to which impermeability needs to be established are, for example, cooling liquids or protective gases, in order to provide a suitable atmosphere for sensitive elements.

In the field of electromobility, components based on aluminum materials are important, in particular due to the low specific weight. In order to join aluminum-containing components so that they are impermeable to media, use has hitherto predominantly been made of soldering. During soldering, a solder needs to be supplied to generate the soldered connection. Soldering is comparatively complex and difficult; in addition, soldered connections can be susceptible to corrosion. It is also possible to adhesively bond aluminum-containing components to one another in order to join them so that they are impermeable to media. Adhesive bonding is also comparatively complex and often requires lengthy curing processes, and the adhesive point can be sensitive to high temperatures.

Welding is a joining method which enables two workpieces to be permanently connected to one another. Laser welding is usually used if the intention is to carry out welding at a high welding speed, with a narrow and slender weld seam shape and with low thermal warpage. During laser welding, energy is fed in via a laser beam. To attain a high welding speed, the laser welding is preferably effected as deep penetration laser welding, a vapor capillary (keyhole) being formed in the component material.

The laser welding of media-impermeable weld seams in the case of aluminum components is, however, difficult. Aluminum-containing workpieces tend to cause strong turbulence in the melt pool during laser welding. This turbulence leads to non-uniform solidification of the weld seam. This can lead to seam collapses, edge notches or holes in the weld seam. The aforementioned problems in combination with cracks and pores at the weld seam can give rise to leaks at the weld seam, with the result that the welded components are not suitable for applications in which impermeability to media matters. Moreover, the strong turbulence in the melt pool during laser welding often results in formation of a considerable amount of welding spatter, which contaminates the surroundings and leads to a loss of material at the weld seam.

DE 10 2010 003 750 A1 discloses altering the beam profile characteristic of a laser beam by means of a multiclad fiber. Here, a laser beam having a core portion and a ring portion can be generated.

DE 10 2016 124 924 A1 discloses a laser welding apparatus which can be used to weld a seal plate on a housing body of a battery, the housing body and the seal plate being manufactured from aluminum. A collimated laser beam is conducted via a shaping device, which comprises a diffractive optical element (DOE) with an opening. The DOE can be used to subdivide an incident laser beam into multiple partial beams, for example into four partial beams, which are arranged corresponding to the corners of a square. Depending on the overlap of the collimated laser beam with the DOE or its opening, part of the collimated laser beam is subdivided into the partial beams by the DOE, or remains unshaped as it passes through the opening.

It has therefore been found in practice that welded aluminum-containing components often have defects and are not impermeable to media.

### SUMMARY

Embodiments of the present invention provide a method for welding at least two aluminum-containing components. Each component has a content of at least 75% by weight of aluminium. The method includes subdividing an output laser beam into multiple partial beams directed onto the components such that multiple laser spots are generated on a surface of the components, and traversing a welding contour on the surface of the components with the multiple laser spots. Laser spot centers of at least three laser spots of the multiple laser spots are arranged in a ring formation. The output laser beam is generated by a multifiber such that each laser spot of the multiple laser spots on the surface of the components has a core portion and a ring portion. The welding contour is at least partially traversed by pivoting a first mirror in a controlled manner by a scanner optical unit.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1a shows a schematic side view of an exemplary welding optical unit, which can be used to carry out part of the method according to embodiments of the invention;

FIG. 1b shows the exemplary welding optical unit from FIG. 1a rotated by 90° according to some embodiments;

FIG. 1c shows a schematic illustration of an exemplary 2-in-1 fiber in cross section, as can be used as laser light cable in FIG. 1a and which makes it possible to provide an output laser beam for the method according to embodiments of the invention;

FIG. 2 shows the weld pattern of one variant of the method according to embodiments of the invention with four laser spots, as can be generated by the exemplary welding optical unit from FIG. 1a;

FIG. 3 shows a schematic longitudinal section of two components during the welding operation with the weld pattern of FIG. 2, to elucidate the method according to embodiments of the invention;

FIG. 4 shows a schematic cross section of the vapor capillary of FIG. 3 in the planes A-A, B-B and C-C of that figure, according to some embodiments;

FIG. 5a shows the weld pattern of one variant of the method according to embodiments of the invention, in which the ring portions of four laser spots are arranged partially overlapping one another and touch one another at a middle point;

FIG. 5b shows a weld pattern of one variant of the method according to embodiments of the invention, in which the ring portions of three laser spots are arranged partially overlapping one another;

FIG. 5c shows a weld pattern of one variant of the method according to embodiments of the invention, in which the ring portions of five laser spots are arranged partially overlapping one another;

FIG. 6a shows a schematic plan view of an exemplary facet plate, as can be used in a welding optical unit, for generating multiple partial beams for the method according to embodiments of the invention;

FIG. 6b shows a schematic cross section of the exemplary facet plate from FIG. 6a, according to some embodiments;

FIG. 6c shows a weld pattern of one variant of the method according to embodiments of the invention with six laser spots in a ring formation and one central laser spot, as can be generated by the exemplary facet plate from FIG. 6a;

FIG. 7 shows an image, from an experiment, of a longitudinal microsection of two aluminum-containing components after carrying out the method according to embodiments of the invention;

FIG. 8 shows a schematic side view of an exemplary welding optical unit with an optical sensor for capturing a welding contour, according to some embodiments;

FIG. 9a shows a schematic front view of an apparatus for welding two aluminum-containing components with multiple laser spots, a plan view of the laser spots being shown at the lower end of the figure, according to some embodiments;

FIG. 9b shows a schematic side view of an apparatus from FIG. 1a, a corresponding plan view of the laser spots being shown at the lower end of the figure, according to some embodiments;

FIG. 10 shows components welded with a butt joint according to some embodiments; and

FIG. 11 shows a transverse microsection of two aluminum-containing components after carrying out the method according to embodiments of the invention.

### DETAILED DESCRIPTION

Embodiments of the invention provide a method for rapidly and at the same time inexpensively producing a reliable, media-impermeable welded connection. Embodiments of the invention also provide an apparatus for producing such a welded connection and a component arrangement having such a media-impermeable welded connection.

Embodiments of the present invention provide a method for welding at least two aluminum-containing components. The components each have a content of at least 75% by weight of aluminium. The welding is effected as deep penetration laser welding. An output laser beam is subdivided into multiple partial beams directed onto the components, such that multiple laser spots are generated on a surface of the components. The multiple laser spots traverse a welding contour on the surface of the components. Laser spot centers of at least three laser spots of the multiple laser spots are arranged in a ring formation. The output laser beam is generated by means of a multifiber, in particular a 2-in-1 fiber, such that the multiple laser spots on the surface of the components each have a core portion and a ring portion, wherein the welding contour is at least partially traversed by a scanner optical unit with a first mirror that is pivoted in a controlled manner.

The scanner optical unit is used to deflect the output laser beam in a rapid and cost-effective manner. The scanner optical unit is advantageous if the welding contour has a curved or angular portion. In curved or angular portions, when the components and/or a laser head are being displaced in a purely mechanical manner, it is necessary to effect braking which can influence the quality of the welding contour. Such braking can be avoided with the scanner optical unit.

For the welding of aluminum-containing components, according to embodiments of the invention, an output laser beam is subdivided into multiple partial beams and correspondingly multiple laser spots on the workpiece surface. At least some of the laser spots (usually all laser spots or all laser spots except for one laser spot) are arranged on the workpiece surface in a ring formation. In addition, provision is made of beam shaping of the output laser beam using a multifiber, preferably a 2-in-1 fiber, which results in a respective subdivision of the laser power into a core portion with a higher power density and a ring portion with a lower power density in the output laser beam and in the partial beams, and thus in the individual laser spots (referred to as “2-in-1 technique” in the case of the 2-in-1 fiber). The multifiber comprises a central core fiber and one or more ring fibers which annularly surround the core fiber. The core portion results from the core fiber, and the ring portion results from the one or more ring fibers (if there are multiple ring fibers, the ring portion comprises multiple individual ring portions which then as a whole form the ring portion). By virtue of all of these measures, it is possible according to embodiments of the invention to achieve high-quality laser welding of aluminum-containing components and in particular to obtain a media-impermeable weld seam with few pores.

If an individual laser spot (single spot) is used, in the case of aluminum-containing components the 2-in-1 technique leads to a certain reduction in spatter formation compared to the single-spot technique with a conventional (unshaped) laser beam, but the remaining instabilities in the aluminum-containing components still have the effect that the weld seam obtained is generally not media-impermeable. Owing to the specific properties of the aluminum in the component material, strong turbulence continues to occur in the melt pool during the welding operation. In the case of an individual beam, the keyhole is possibly too small compared to the melt pool produced. In particular, many pores are produced which then make the weld seam media-permeable.

Surprisingly, however, the use of a multifiber or the 2-in-1 technique with multiple laser spots in a ring arrangement made it possible to obtain stable keyholes when laser welding aluminum-containing components. According to embodiments of the invention, it is possible to achieve larger keyholes (compared to individual keyholes in the case of individual laser spots); they are more stable and do not collapse. Instead, the melt can be displaced more reliably owing to the larger keyholes. A homogeneous solidification of the weld seam can be achieved.

The laser spot centers of the respective laser spots (that follow one another/are adjacent in the ring formation) of the ring formation can conceivably be connected to one another in the manner of a polygon which encloses an inner surface (polygon surface). The deep penetration welding according to embodiments of the invention in the aluminum-containing components can substantially take place in the region of this polygon surface.

The laser welding according to embodiments of the invention generates a large melt volume, in particular also preceding a respective vapor capillary (keyhole); in particular, those partial regions of the ring portions which are on the outside (with respect to the ring formation) can increase the melt volume. The laser spots can form a common melt in the process. The leading, large melt volume can reduce the dynamics of the melt and, as a result, turbulence.

According to embodiments of the invention, moreover, large keyholes can be established and the keyhole geometry changes (compared to a keyhole in the case of a single spot), and the absorption behavior of the laser radiation changes correspondingly. In particular, a common keyhole can be formed by all the laser spots or partial beams together. The melt can then flow around the respective vapor capillary as the welding process continues. Overall, a high keyhole stability can be achieved. High welding speeds with good seam quality are possible, and in particular media-impermeable weld seams of the aluminum-containing weld seams can be produced without problems, in particular with a butt joint. Preferably, in this case a cover is inserted into a component and welded with a butt joint.

The arrangement of at least three laser spots in a ring formation makes it possible to reduce the directional dependence of the welding process. With four or more laser spots in the ring formation, the welding process is already largely direction-independent (given a symmetrical arrangement of the laser spots). Moreover, the ring formation can stabilize a common keyhole of the aluminum-containing components very well. All of the laser spots on the workpiece surface are referred to as the weld pattern here.

The partial beams are typically generated by virtue of the output laser beam being conducted between a collimation optical unit and a focusing optical unit via one or more optical elements, which protrude at least into part of the beam cross section of the output laser beam. Typical optical elements for this are wedge plates; however, other diffractive and refractive optical elements can also be used. In a preferred variant, two bifocal inserts arranged at an angle of 90° to one another are used. It is similarly possible for the optical element used to be a facet plate, which has annularly arranged facets (outer facets) which correspond to the desired number of laser spots of the ring formation and are angled (inclined) at an angle β, typically where 0<β≤0.50°, often β≤0.25°, in relation to a base plane extending transversely to the beam propagation direction. The outer facets are typically at 360°/N relative to one another, where N: the number of laser spots in the ring formation, rotated in relation to one another about a central axis (optical axis of the facet plate, corresponding to the beam propagation direction). If a central laser spot is also desired, a further facet (central facet) which is parallel to the base plane may be provided, with the outer facets radially inwardly adjoining the central facet. The central facet is typically in the form of a regular polygon. If a central laser spot is not desired, the outer facets can radially inwardly simply abut one another at a common central point. A facet plate makes it possible to generate fundamentally any desired number of laser spots according to the configuration of the facet plate.

The laser spots are typically the same size. Typically, the laser spots of the ring formation are each allotted the same laser power. With respect to their laser spot centers, the laser spots of the ring formation typically have the same distance (radius) from a common center (centroid) of all of the laser spots.

The method is preferably characterized in that a mean power density in the core portion is higher than a mean power density in the ring portion.

The proportions of power for the core portion and the ring portion in the case of a respective laser spot can be set via the proportion of the output laser beam that is introduced into the core fiber and into the one or more ring fibers of the multifiber, respectively. Usually, the mean power density in the core portion is at least 2 times, often at least 4 times, as high as in the ring portion. The (outer) boundaries of the core portion and the ring portion can be determined as the location where the local power density is lower than half the mean power density in the core portion or the ring portion, in the case of multiple ring fibers in the outermost individual ring portion; in the case of an approximately uniform power density within the core portion and the ring portion, in the case of multiple ring fibers of the outermost individual ring portion, this meets a FWHM criterion. The diameters, or their ratio, of the core fiber and the (outermost) ring fiber at the imaged fiber end determine the diameters, or their ratio, respectively, of the core portion and the ring portion in a respective laser spot. The imaging ratio and thus the absolute size of the laser spots can be selected or set via the collimation optical unit and the focusing optical unit.

The welding contour is traversed continuously along its profile by the laser spots, typically at a constant feed speed (welding speed). This produces the (media-impermeable) weld seam. It should be noted that, when the welding contour is being traversed, the local feed direction (welding direction), and as a result also the orientation of the weld pattern in relation to the local feed direction, can change. Owing to the at least extensive directional independence according to embodiments of the invention of the weld pattern, such changes of the local feed direction are largely non-critical in the case of the welding according to embodiments of the invention of the components.

The welding contour can be formed with a butt joint, as a fillet weld or a lap weld. The laser welding can be operated as partial penetration welding or as full penetration welding. Preferably, the welding of the aluminum-containing components is effected as partial penetration welding with a butt joint, and preferably as partial penetration welding with a lap joint. It should be noted that the expression “components which are welded to one another according to embodiments of the present invention” is to be understood to mean locally with respect to the laser welding operation; correspondingly, the components to be welded can be separate before the laser welding or already be connected to one another independently of the connection to be welded.

Preferably, the welding contour is traversed predominantly, in particular completely, by the scanner optical unit with the first mirror that is pivoted in a controlled manner.

Preferably, when the welding contour is being traversed, the scanner optical unit deflects the output laser beam by way of a second mirror that is pivoted in a controlled manner in addition to the first mirror. The first mirror can deflect the output beam in a first lateral direction (X direction), and the second mirror can deflect the output beam in a second lateral direction (Y direction). The subdivision of the movement in the X direction at the first mirror and in the Y direction at the second mirror makes it possible to carry out the deflection at a very high speed.

In an advantageous design refinement, the scanner optical unit preferably deflects the output laser beam after the output laser beam has been collimated and before the output laser beam is focused.

The output laser beam may also be subdivided into multiple partial beams before the output laser beam is deflected by the scanner optical unit.

After a first traversal of the welding contour, the welding contour may be at least partially traversed for a second time, the second traversal of the welding contour also being effected by the scanner optical unit.

Preferably, the welding contour is traversed completely during the second traversal. As a result, a completely media-impermeable welding contour is easily achieved and the method is simplified.

The components preferably comprise at least 90% by weight of aluminum.

One component may comprise die-cast aluminum or a wrought aluminum alloy. Preferably, one component consists of die-cast aluminum or a wrought aluminum alloy. Further preferably, one component consists of die-cast aluminum and the other component consists of a wrought aluminum alloy. Such component combinations in practice cannot be connected productively in media-impermeable fashion by welding without the method according to embodiments of the invention.

Preferably, an Al 1XXX, 3XXX, 5XXX, 6XXX alloy is used as wrought aluminum alloy.

The second traversal should preferably melt less material than the first traversal. In a further preferred embodiment of the invention, the second traversal is therefore effected with a lower power and/or a higher feed speed than the first traversal. The second traversal is preferably effected with 2% to 20%, in particular with 5% to 15%, preferably with 8% to 12%, less power per laser spot than the first traversal. The second traversal is preferably effected with a 2% to 20%, in particular with a 5% to 15%, preferably with a 8% to 12%, higher feed speed than the first traversal.

A lateral offset during the second traversal is preferably less than 20 mm, in particular less than 10 mm, preferably less than 5 mm, in relation to the first traversal.

Further preferably, the rest of the parameters for the second traversal are selected to be the same as the first traversal. The welding contour created during the first traversal is completely or virtually completely melted and homogenized as a result.

The welding depth is preferably less than 10 mm Preferably, the welding depth is less than 4 mm, in particular is between 1 mm and 3 mm.

The twice-traversed welding contour may be captured by an optical sensor and defects can be detected. Possible defects can be identified and eliminated as a result. The assessment of the welding contour makes it possible to avoid complex handling, in particular unclamping, checking and reclamping of the components.

The optical sensor may be in the form of a camera or a photodiode.

The image can be created directly after the second traversal of the welding contour. By creating the image directly after the second traversal of the welding contour, the process luminous emission during the second traversal can be detected and evaluated.

The beam path of the optical sensor can in this respect extend coaxially with the beam path of the output laser beam, with the result that the method can be implemented easily in design terms.

The welding contour may be at least partially traversed a third time after the second traversal. A third traversal makes it possible to provide a media-impermeable, preferably gas-impermeable, welded connection.

The third traversal is preferably effected only if at least one defect was identified after the second traversal.

In order to simplify the method, the welding contour is preferably traversed completely during the third traversal.

For the third traversal, the welding depth is preferably selected to be substantially the same as for the second traversal. In a preferred embodiment of the invention, the third traversal is therefore effected with the same parameters as the second traversal to within ±10%, in particular to within ±5%, preferably to within ±2%. The third traversal can also be effected with a higher power than the second traversal, but in that case preferably with a correspondingly higher feed speed.

In a preferred variant of the method according to embodiments of the invention, the first traversal is effected with selected parameters, the second traversal is effected with lower power but the same feed speed (as a result of which a smaller welding depth is achieved during the second traversal than during the first traversal), and the third traversal is effected with a higher feed speed and higher power than the second traversal (as a result of which substantially the same welding depth is achieved as during the second traversal).

The thrice-traversed welding contour may be captured by an optical sensor and defects can be detected. The optical sensor is preferably the same optical sensor used to capture the twice-traversed welding contour. Typically, at the latest after the third traversal no more defects are detected, and therefore the welded components can be certified as a part of acceptable quality by the optical assessment.

The image is preferably created during the third traversal of the welding contour. Preferably, the image is created in the same way during the third traversal of the welding contour as during the second traversal of the welding contour. This makes it possible to significantly reduce programming outlay and process complexity.

Preference is given to a variant of the method according to embodiments of the invention for welding aluminum-containing components that provides for the at least two components to be welded to one another with a butt joint, and for the laser welding to be effected
as partial penetration welding, the welding depth corresponding to a cover thickness or at least 75% of a cover thickness,

or alternatively with a lap joint:
as partial penetration welding, the partial penetration welding being effected to at least 10% of a component thickness of the lower component of the lap joint, or
as full penetration welding through all the components of the lap joint. Welding with a lap joint has proven successful in practice for manufacturing media-impermeable weld seams, especially if it is effected as partial penetration welding. The partial penetration welding makes it possible to establish a reliable seal by retaining solid material of the lower component.

A variant in which a common vapor capillary for all the laser spots is formed in the components and is surrounded by a common melt pool is preferred. The common vapor capillary is a continuous space in the components to be welded which contains metal vapor and is surrounded by liquid melt; the vapor capillaries of the individual laser spots (if they were to be used in isolation) combine to form this continuous space. The common vapor capillary (common keyhole) can be established by a suitable method regime, in particular a not excessive distance between the laser spots of the ring formation. The common keyhole is considerably larger than a keyhole that could be generated with an individual laser beam (single spot). The larger, and geometrically then also differently shaped, keyhole influences the absorption behavior of the incident laser radiation. Multiple intensity peaks, corresponding to the multiple laser spots of the ring formation, are distributed annularly at the common keyhole in a manner corresponding to the ring formation; an intensity peak of a further laser spot in the middle of the ring formation may also be added. A keyhole is stable at the location of a local intensity peak; the multiple intensity peaks at the common keyhole have the effect that the common, large keyhole is stabilized overall. By contrast, in the case of a single spot keyhole, only the region of a single intensity peak can be stabilized. The common vapor capillary preferably protrudes (in the case of a lap joint) deep enough that the cross section of the common vapor capillary also forms a continuous surface at an interface between the overlapping components to be welded. Furthermore, the common vapor capillary preferably protrudes (generally) deep enough that the common vapor capillary, in cross section, forms a continuous surface at the height of half the maximum depth of all the segments of the common vapor capillary. The cross section is assumed to be perpendicular to the beam propagation direction here.

A variant in which the multiple laser spots form an arrangement that has a rotational symmetry with an order corresponding to the number of laser spots of the ring formation is preferred. The rotational symmetry has the effect of achieving high directional independence of the laser welding, that is to say the relative orientation of all of the laser spots in relation to the current feed direction is of no, or only very little, importance for the welding process.

In one variant, it is provided that all the laser spots form the ring formation. This can be established easily, for example with two bifocal inserts in the case of four laser spots in the ring formation. In particular, no laser spot is provided in the middle of the ring formation here. If there are few laser spots in the ring formation (for example in the case of 3-5 laser spots in the ring formation), it is generally possible to establish a well-stabilized, common keyhole in this way.

In an alternative variant, a laser spot center of a laser spot is arranged in the middle of the ring formation. In other words, the laser spots of the ring formation are supplemented by a further laser spot arranged in the middle of the ring formation. This makes it possible to additionally stabilize a common keyhole, in particular if there are many laser spots in the ring formation (for example in the case of 4 or more, preferably 6 or more laser spots in the ring formation); in the case of many laser spots in the ring formation, usually a larger radius of the laser spot centers of the laser spots of the ring formation with respect to a common center of the laser spots is also selected, in order to reduce overlaps of the ring portions of the laser spots. In that case, the middle laser spot can stabilize the central region of the common keyhole and prevent a local recess in the keyhole in the central region.

In one variant, it is provided that the ring formation is formed by exactly three laser spots, in particular with the welding contour extending such that, during the laser welding, at least predominantly with respect to the local feed direction,
one laser spot of the ring formation is a leading laser spot and
two laser spots of the ring formation are trailing laser spots having the same position with respect to the local feed direction.

With three laser spots in the ring formation, the directional dependence can already be considerably reduced in comparison with two (or even more) laser spots in a linear formation. The preferred predominant alignment of the weld pattern in relation to the local welding direction/feed direction with one leading and two trailing laser spots has proven successful in practice.

A variant in which the ring formation is formed by exactly four laser spots is preferred. This already makes it possible to easily bring about very extensive directional independence. The exactly four laser spots of the ring formation are preferably arranged in a square shape.

In a further development of this variant, the welding contour extends such that, during the laser welding, at least predominantly with respect to the local feed direction,
one laser spot of the ring formation is a leading laser spot,
two laser spots of the ring formation are arranged in the middle with the same position with respect to the local feed direction,
and one laser spot of the ring formation is a trailing laser spot.

This predominantly applied orientation of the weld pattern (also referred to as “trapezium” arrangement) makes it possible to establish a comparatively wide weld seam with four laser spots in the ring formation and to obtain a large and stable melt pool.

Preference is given to an alternative further development in which the welding contour extends such that, during the laser welding, at least predominantly with respect to the local feed direction,
two laser spots of the ring formation are leading laser spots having the same position with respect to the local feed direction,
and two laser spots of the ring formation are trailing laser spots having the same position with respect to the local feed direction.

This predominantly applied orientation of the weld pattern (also referred to as “square” arrangement) makes it possible to establish a comparatively narrow weld seam with four laser spots in the ring formation and, as a result, to achieve deep melting with a high welding speed and a stable melt pool. The predominant local welding direction/feed direction can correspond to one of the main coordinate axes of the laser welding apparatus used. It should be noted that when traveling along curves, the orientation of the weld pattern changes, for example from the square arrangement to the trapezium arrangement and back to the square arrangement again when passing through a 90° curve.

In a further variant, the ring formation is formed by exactly five laser spots, in particular with the welding contour extending such that, during the laser welding, at least predominantly with respect to the local feed direction,
one laser spot of the ring formation is a leading laser spot,
two laser spots of the ring formation are arranged in the middle with the same position with respect to the local feed direction,
and two laser spots of the ring formation are trailing laser spots having the same position with respect to the local feed direction.

This variant achieves even better directional independence. With the one leading, the two middle and the two trailing laser spots in the preferably predominantly applied orientation of the weld pattern with respect to the feed direction, a calm melt pool is obtained.

In a further variant, the ring formation is formed by exactly six laser spots. In addition, a further laser spot may be provided in the middle in the ring formation. This makes it possible to achieve even more extensive directional independence. It should be noted that a number of 3 to 6 laser spots in the ring formation is preferred embodiment of the invention; a higher number generally entails only small improvements in terms of directional independence or melt pool stability.

Particular preference is given to a variant in which the ring portions of laser spots that are adjacent in the ring formation are arranged touching one another. This makes it possible to achieve a very stable, common keyhole during the laser welding of the aluminum-containing components. The ring portions of adjacent laser spots of the ring formation are considered to touch one another when these laser spots have a distance between their laser spot centers that corresponds to the sum of half the respective diameter of their ring portions, with a tolerance of ±10% with respect to this sum.

In an alternative variant, the ring portions of laser spots that are adjacent in the ring formation are arranged overlapping one another, in particular with the core portions of laser spots of the ring formation not overlapping the ring portions of laser spots that are adjacent in the ring formation. The overlap of the ring portions of the laser spots, in particular without an overlap of ring portions and core portions, often makes it possible to reduce local projections and recesses of a common keyhole in relation to the depth in the components to be welded.

A further development of this variant in which, at any location, at most two ring portions of laser spots of the ring formation overlap one another is preferred. This has proven successful for a stable melt pool in the case of aluminum-containing components.

Preference is also given to a further development in which the laser spots of the ring formation comprise a common center, where the ring portions of the laser spots of the ring formation touch one another, in particular with exactly four laser spots being arranged in the ring formation. In this variant, which typically is configured without a laser spot in the middle of the ring formation, a calm and large keyhole with only small local projections and recesses in the depth of the components to be welded can be established.

Also advantageous is a variant in which the ring portions of all the laser spots of the ring formation overlap one another in a central region, in particular with exactly three laser spots being arranged in the ring formation. In particular in the case of only a few laser spots, for instance three laser spots in the ring formation and without a further laser spot in the middle of the ring formation, the overlap of the ring portions of the laser spots of the ring arrangement in the central region makes it possible to generate an auxiliary intensity peak, which in addition to the intensity peaks of the core portions of the laser spots can stabilize a common keyhole.

In a preferred variant, it is provided that, for a diameter DK of the core portion and a diameter DR of the ring portion, the following applies: 2≤DR/DK≤10, preferably 2.5≤DR/DK≤6, preferably 3.5≤DR/DK≤5, and that, for a power proportion LK of the core portion in relation to the overall power in a respective laser spot, the following applies: 10%≤LK≤90%, preferably 30%≤LK≤70%, preferably 40%≤LK≤60%. These parameter ranges have proven successful in practice in the case of aluminum-containing components for achieving a stable keyhole and media-impermeable weld seams.

Preference is also given to a variant which provides that
the components have a component thickness BD where 0.5 mm≤BD≤5.0 mm, and/or
the components are manufactured from aluminum materials of the 3000, 5000 or 6000 series, and/or
the core portions of the laser spots have a diameter DK where 11 μm≤DK≤200 μm, preferably 50 μm≤DK≤150 μm, and the ring portions of the laser spots have a diameter DR where 50 μm≤DR≤700 μm, preferably 200 μm≤DR≤550 μm, and/or
a mean laser power P of the output laser beam is applied where P≥2 kW, preferably P≥4 kW, and/or
a welding speed SG is applied where SG≥5 m/min, preferably SG≥10 m/min.

These parameters have also proven successful in practice for laser welding aluminum-containing components. In particular, according to embodiments of the invention, a high welding speed SG can be established.

Embodiments of the invention also provide a component arrangement produced by a method described here, wherein the component arrangement is impermeable to a medium at the welding contour. The welding contour is preferably water-impermeable, in particular impermeable to a cooling liquid, preferably gas-impermeable. By application of the method according to embodiments of the invention, the component arrangement can be easily and reliably manufactured with a weld seam (or welded welding contour) in media-impermeable fashion.

Embodiments of the invention also provide an apparatus for welding at least two aluminum-containing components, in particular for welding by a method described here, the apparatus having the following features:
a) a 2-in-1 fiber for emitting an output laser beam;
b) a dividing device for subdividing the output laser beam into multiple partial beams which can be directed onto the components such that multiple laser spots are generated on a surface of the components, wherein a welding contour can be traversed by the multiple laser spots on the surface of the components, and wherein laser spot centers of at least three laser spots of the multiple laser spots can be arranged in a ring formation, wherein the multiple laser spots on the surface of the components each have a core portion and a ring portion;
c) a scanner optical unit with a first mirror that can be pivoted in a controlled manner for the traversal of the welding contour.

In addition to the first mirror, the scanner optical unit may have a second mirror that can be pivoted in a controlled manner for the traversal of the welding contour.

Further advantages of the invention will emerge from the description and the drawing. Similarly, according to embodiments of the invention, the features mentioned above and those yet to be explained further may be used in each case individually or together in any desired combinations. The embodiments shown and described should not be understood as an exhaustive enumeration, but rather are of exemplary character for outlining the invention.

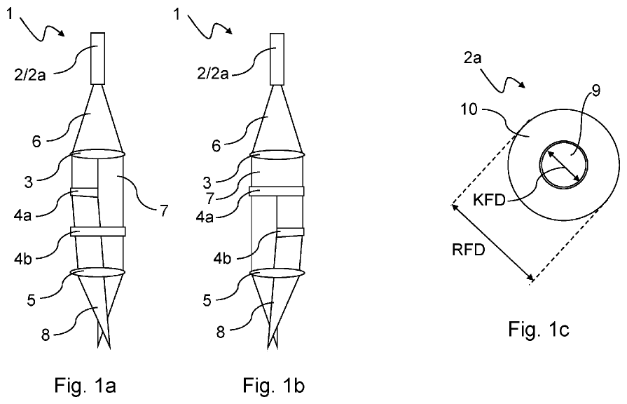

FIG. 1a shows a schematic side view of an exemplary welding optical unit 1, which can be used to carry out part of the method according to embodiments of the invention in a preferred variant. FIG. 1b shows the welding optical unit 1 from FIG. 1a rotated by 90°.

The welding optical unit 1 comprises a laser light cable 2, which is in the form of a multifiber, in this case a 2-in-1 fiber 2a, a collimation lens 3, two bifocal inserts 4a, 4b, which in this case are in the form of glass wedges, and a focusing lens 5. The bifocal inserts 4a, 4b are arranged one behind the other and are arranged rotated by 90° in relation to one another.

The laser light cable 2 is used to provide an output laser beam 6, which emerges at one fiber end of the laser light cable 2. The fiber end is in the focus of the collimation lens 3, and the output laser beam 6 is collimated by the collimation lens 3, as a result of which the output laser beam 6 becomes a collimated laser beam 7. The collimated laser beam 7 is guided to the bifocal inserts 4a, 4b. The bifocal inserts 4a, 4b in this instance each occupy approximately half of a cross section of the collimated laser beam 7. As a result, the collimated laser beam 7 can be subdivided into four partial beams 8 in the exemplary welding optical unit 1 shown here. The partial beams 8 are focused by the focusing lens 5 onto a surface of a component (not illustrated) to be welded, as a result of which a weld pattern composed in this case of four laser spots of the same size is generated on the surface of the component.

The selected mean laser power P of the output laser beam 6 can be for example P≥2 kW, preferably P≥4 kW.

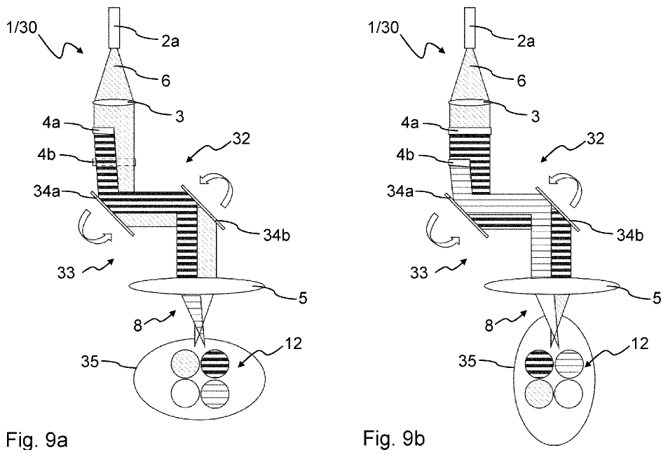

The welding optical unit 1 is refined in accordance with embodiments of the invention in FIGS. 9a and 9b (see below).

FIG. 1c shows, by way of example, a cross section of the 2-in-1 fiber 2a, which makes it possible to provide the output laser beam for the method according to embodiments of the invention.

The 2-in-1 fiber 2a comprises a core fiber 9 with a core fiber diameter KFD and a ring fiber 10 with a ring fiber diameter RFD. Typically, for example 11 μm≤KFD≤200 μm, preferably 30 μm≤KFD≤150 μm, can be selected for the core fiber diameter KFD, and for example 30 μm≤RFD≤700 μm, preferably 100 μm≤RFD≤550 lam, can be selected for the ring fiber diameter RFD. The imaging ratio of the welding optical unit (cf. FIG. 1a) which comprises the 2-in-1 fiber is selected to be 1:1 in the embodiment; in other embodiments, it is for example also possible to select an imaging ratio >1:1.

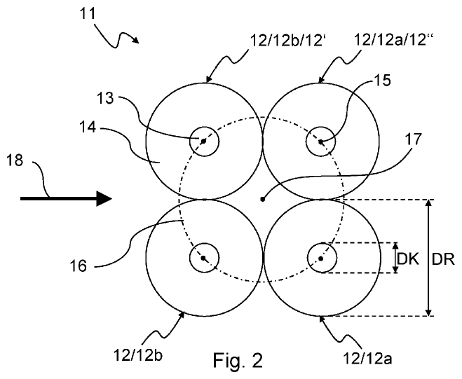

The 2-in-1 fiber makes it possible to generate a laser beam which has a core portion and a ring portion (see, in this respect, for example FIG. 2 with respect to the laser spots) and serves as output laser beam in the welding optical unit (cf. FIG. 1a). To this end, an original laser beam (not shown in more detail) is fed partially into the core fiber 9 and partially into the ring fiber 10, for example via an optical wedge (not illustrated in more detail) pushed partially into the original laser beam.

FIG. 2 shows a schematic illustration of a weld pattern 11 on the surface of a component to be welded, as can be generated by the exemplary welding optical unit from FIG. 1a.

The weld pattern 11 in this case comprises four laser spots 12 of the same size. The four laser spots 12 each have a core portion 13 and a ring portion 14, since the output laser beam is generated by the 2-in-1 fiber and accordingly for its part already has a core portion and a ring portion.

Each laser spot 14 has a laser spot center 15. The core portion 13 in this instance has a diameter DK of 100 μm and the ring portion 14 in this instance has a diameter DR of 400 μm. The ratio DR/DK is accordingly 4.

For a power proportion LK of the core portion 13 of an individual laser spot 12, LK=50% can be selected. In the variant shown here, the ring portion 14 has a surface area about 15 times greater than the core portion 13. Here, a mean power density in the core portion 13 is then approximately 15 times greater than a mean power density in the ring portion 14.

The laser spots 12 are arranged in a ring formation 16; the laser spot centers 15 make it possible to define the corner points of a polygon (in this instance a square) which encloses an inner surface. The distance between two laser spot centers 15 of laser spots 12 that are adjacent in the ring formation 16 and next to one another (for example the laser spot centers 15 of the laser spots 12′ and 12″) is 400 μm in this case. In the variant shown here, the ring portions 14 of the laser spots 12 that are adjacent in the ring formation 16 touch one another exactly. The distance between the laser spot centers 15 of the laser spots 12 that are adjacent in the ring formation 16 corresponds to the sum of half the diameter DR of each of the ring portions 14 of the laser spots 12 involved.

The weld pattern 11 here has a fourfold rotational symmetry, since the ring formation 16 is formed by four laser spots 12 which can be transformed into one another by rotation about a common center (centroid) 17 by 90°. The laser spot centers 15 of the laser spots 12 of the ring formation 16 in this case lie on a circular line (illustrated by a dash-dotted line) around the common center 17.

With respect to a local feed direction 18, the weld pattern 11 is arranged such that two laser spots 12a are leading laser spots and two laser spots 12b are trailing laser spots.

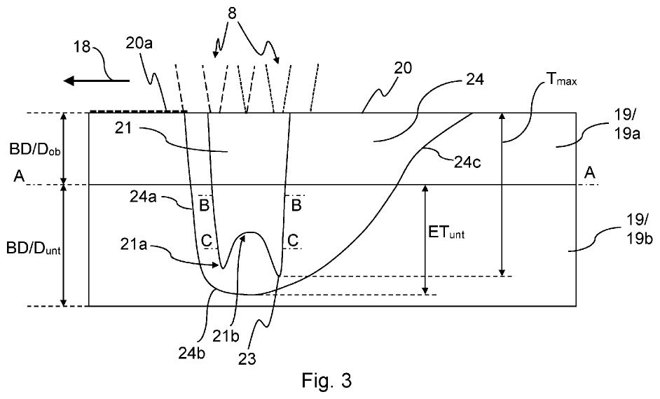

FIG. 3 shows a schematic longitudinal section of two components 19 during the welding operation with a weld pattern as illustrated in FIG. 2, to elucidate the method according to embodiments of the invention in a preferred variant. The joining situation of the two components 19 is a lap joint. As an alternative, and not shown here, the joining situation of the two components 19 may also be a butt joint.

The components 19 are manufactured from an aluminum material. An upper component 19a in this case has a component thickness BD or thickness Dᵤₚₚ of about 2 mm A lower component 19b in this case has a component thickness BD or thickness D_{low} of about 3 mm Here, the welding is effected as partial penetration welding. The longitudinal section is selected centrally through two laser spots that lie next to one another with respect to the feed direction 18.

The partial beams 8 present in the longitudinal section of FIG. 3 are directed from the welding optical unit (not shown) onto the surface 20 of the upper component 19a. The partial beams 8 penetrate the components 19 from the surface 20 and evaporate the aluminum material in their immediate surroundings. The action of all the partial beams 8 or all the laser spots causes a common vapor capillary 21 to form (also referred to as common keyhole or common metal vapor capillary), which extends into the lower component 19b. The common vapor capillary 21 forms a continuous volume in the components 19. In the regions close to the core portions of the partial beams 8, the common vapor capillary 21 has segments 21a that extend deeper (“projections”). In a region between the partial beams 8, the common vapor capillary 21 has a segment 21b that extends less deeply (“recess”). A maximum depth Tₘₐₓ of the common vapor capillary 21 at a lowermost point 23 in this instance is about 4 mm.

The combination of the 2-in-1 technique with multiple laser spots generated by the partial beams 8 makes the common vapor capillary 21 stable.

In the surroundings of the common vapor capillary 21, the aluminum material is melted, as a result of which a melt pool 24 of liquid aluminum material forms. Since, during the welding operation, the partial beams 8 are moved relative to the components 19 in the feed direction 18 along a welding contour 20a, in the illustration shown here toward the left, the melt pool 24 sags toward the right in cross section. Aluminum material is melted at a left-hand edge 24a and at a lower edge 24b of the melt pool 24, whilst aluminum material re-solidifies at a right-hand edge 24c of the melt pool 24.

The partial penetration welding in the lower component 19b is effected to a welding depth ET_{low}, which in the case shown is about 85% of the component thickness D_{low}. In this way, a good and media-impermeable weld can be obtained. In a variant which is not shown, it is similarly possible for the laser welding to be effected as full penetration welding through all the components 19 of the lap joint.

The selected aluminum materials for the components 19 can be materials of the 3000, 5000 or 6000 series. A selected welding speed SG can be SG≥5 m/min, preferably SG≥10 m/min.

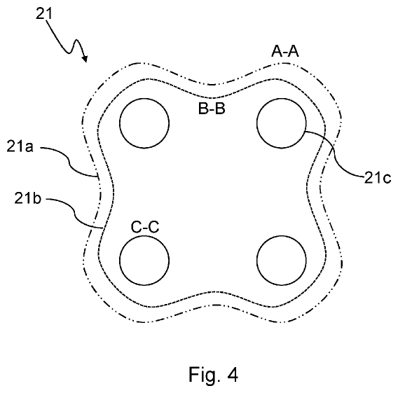

FIG. 4 shows schematic cross sections of the vapor capillary 21 of FIG. 3 in the planes A-A, B-B and C-C of that figure.

The dash-dotted line shows an outline 21a of the vapor capillary 21 in the plane A-A of FIG. 3, which lies in the interface of the upper and lower component, that is to say at a depth of about 2 mm. The vapor capillary 21 forms a continuous surface in this case.

The dashed line shows an outline 21b of the vapor capillary 21 in the plane B-B of FIG. 3, which in terms of depth corresponds to half the maximum depth Tₘₐₓ of the common vapor capillary, which in this instance is about 2.5 mm deep. Here, the vapor capillary 21 forms a somewhat smaller but still continuous surface.

An outline 21c of the vapor capillary 21 about 3 8 mm deep in the vapor capillary 21 in the plane C-C of FIG. 3 is shown with a continuous line. In cross section at this depth, the vapor capillary forms four separate (non-continuous) partial regions which are each approximately circular. Plane C-C thus intersects the vapor capillary only in the region of the local projections.

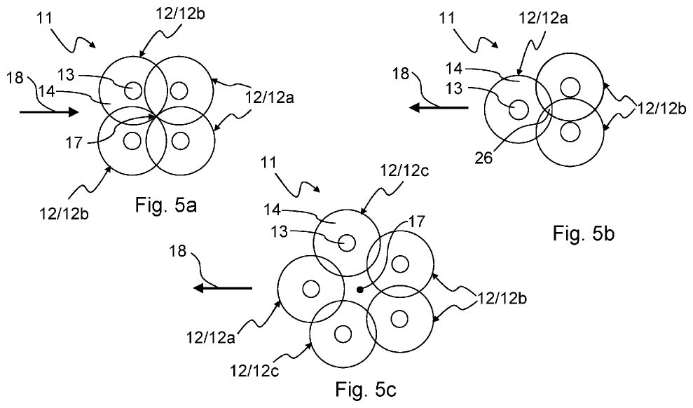

FIG. 5a shows a schematic illustration of a weld pattern 11 in cross section with four laser spots 12 in a ring formation, for a further embodiment of the invention.

Here, the laser spots 12 are all the same size. The core portion 13 in this instance has a diameter DK of 100 μm and the ring portion 14 in this instance has a diameter DR of 400 μm. The ratio DR/DK is accordingly 4.

The distance between two (diagonally) opposite laser spot centers of the laser spots 12 is 400 μm in this instance. In the variant shown here, the ring portions 14 of the opposite laser spots 12 touch one another exactly in the common center 17. The adjacent laser spots 12 are arranged overlapping one another. The core portions 13 do not overlap. The weld pattern 11 here has a fourfold rotational symmetry, since the ring formation is formed by four laser spots 12 which can be transformed into one another by rotation about the common center 17 by 90°.

With respect to the local feed direction 18 depicted, the weld pattern 11 is arranged such that the two laser spots 12a are leading laser spots and the two laser spots 12b are trailing laser spots. The two laser spots 12a are at identical positions with respect to the local feed direction 18. Similarly, the two laser spots 12b are at identical positions with respect to the local feed direction 18.

FIG. 5b shows a schematic illustration of a weld pattern 11 in cross section with three laser spots 12 in a ring formation, in a further embodiment of the invention.

Here, the laser spots 12 are all the same size. The core portion 13 in this instance has a diameter DK of 300 μm and the ring portion 14 in this instance has a diameter DR of 800 μm. The ratio DR/DK is accordingly 2.67.

The adjacent laser spots 12 are arranged overlapping one another with respect to the ring portions 14 and all three laser spots 12 overlap in the ring portions 14 in a central region 26. The core portions 13 do not overlap.

With respect to the local feed direction 18 shown, the weld pattern 11 is arranged such that one laser spot 12a is a leading laser spot and two laser spots 12b are trailing laser spots. The two laser spots 12b are at identical positions with respect to the local feed direction 18. In this case, the laser spots 12b are spaced apart from one another to a somewhat smaller extent than the leading laser spot 12a is from each of the trailing laser spots 12b (with respect to the laser spot centers in each case).

FIG. 5c shows a schematic illustration of a weld pattern 11 in cross section with five laser spots 12 in a ring formation, in a further embodiment of the invention.

Here, the laser spots 12 are all the same size. The core portion 13 in this instance has a diameter DK of 100 μm and the ring portion 14 in this instance has a diameter DR of 400 μm. The ratio DR/DK is accordingly 4.

The distance between two laser spot centers 15 of the laser spots 12 that are adjacent in the ring formation is approximately 350 μm in this instance. In the variant shown here, the laser spots 12 that are adjacent in the ring formation are arranged overlapping one another by way of the ring portions 14. The weld pattern 11 here has a fivefold rotational symmetry, since the ring formation is formed by five laser spots 12 which can be transformed into one another by rotation about the common center 17 by 72°.

With respect to the local feed direction 18 shown, the weld pattern 11 is arranged such that one laser spot 12a is a leading laser spot, two laser spots 12b are trailing laser spots, and two laser spots 12c are arranged in the middle between the laser spots 12a, 12b. The two trailing laser spots 12b are at identical positions with respect to the local feed direction 18. Similarly, the two middle laser spots 12c are at identical positions with respect to the local feed direction 18.

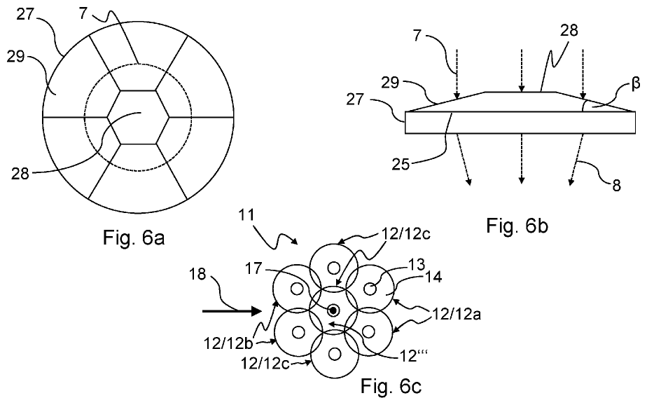

FIG. 6a shows a schematic plan view of an exemplary facet plate 27, as can be used in a welding optical unit, for generating multiple partial beams for the method according to embodiments of the invention.

In the form shown here, the facet plate 27 comprises a regularly hexagonal central facet 28 (“central facet”). The facet plate 27 comprises six outer facets 29 (“outer facets”) arranged around said central facet. The collimated laser beam 7 is incident on the facet plate 27.

FIG. 6b shows a schematic cross section of the exemplary facet plate 27 from FIG. 6a.

The outer facets 29 are of wedge-shaped form. A facet angle β in this instance is approximately 0.15°, measured with respect to a base plane 25 which is perpendicular to the direction of incidence of the collimated laser beam 7. The collimated laser beam 7 is incident on the facet plate 27. In the region of the central facet 28, there is no deflection of the collimated laser beam 7. In the regions of the six outer facets 29, the collimated laser beam 7 is deflected (refracted). One non-deflected partial beam 8 and six deflected partial beams 8 are thus produced.

FIG. 6c shows a weld pattern 11 of one variant of the method according to embodiments of the invention with six laser spots 12 in a ring formation and one central laser spot 12, as can be generated by the exemplary facet plate 27 from FIG. 6a. The central laser spot 12 is also denoted 12′″ here.

Here, the laser spots 12 are all the same size. The core portion 13 in this instance has a diameter DK of 100 μm and the ring portion 14 in this instance has a diameter DR of 400 μm. The ratio DR/DK is accordingly 4.

The distance between two laser spot centers 15 of the laser spots 12 that are adjacent in the ring formation is approximately 350 μm in this instance. In the variant shown here, the laser spots 12 that are adjacent in the ring formation are arranged overlapping one another by way of the ring portions 14. The central laser spot 12′″ is arranged overlapping all the other laser spots 12 with respect to the ring portions 14. The core portions 13 do not overlap. The weld pattern 11 in this instance has a sixfold rotational symmetry, since the ring formation is formed by six laser spots 12 which can be transformed into one another by rotation about the common center 17 by 60°; the central laser spot 12′″ remains unaffected by the rotation, since its laser spot center coincides with the common center 17.

With respect to the local feed direction 18, the weld pattern 11 is arranged such that the two laser spots 12a are leading laser spots, the two laser spots 12b are trailing laser spots, and the three laser spots 12c are arranged in the middle between the laser spots 12a, 12b.

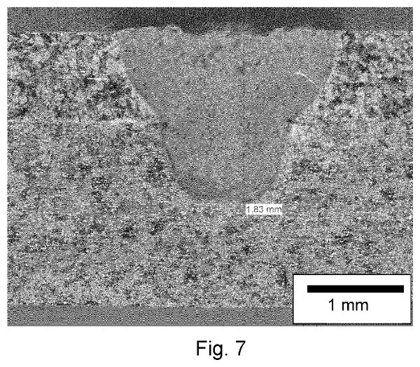

FIG. 7 shows an image, from an experiment, of two aluminum-containing components which were welded to one another with a lap joint when carrying out one variant of the method according to embodiments of the invention. A transverse microsection was made and photographed in an optical microscope.

The upper component has a component thickness of about 1 mm, and the lower component has a component thickness of about 2 mm. The welding was effected by partial penetration welding to about 40% into the lower component; the welding direction was perpendicular to the plane of the drawing. A virtually pore-free, media-impermeable weld seam was obtained.

In the present example, the weld pattern of FIG. 2 (see above) was applied, with four laser spots in a square arrangement touching one another. An (overall) mean laser power P=3 kW and a welding speed SG=5 m/min were selected. The power proportion in the core was 70%, the core diameter DK was 100 μm, and the ring diameter DR was 400 μm for each laser spot. The aluminum-containing components were manufactured from the aluminum alloy AW-5083.

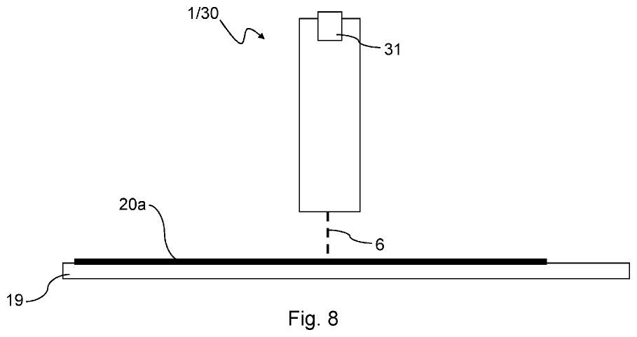

FIG. 8 shows an apparatus 30 with a welding optical unit 1 for welding components 19 or for generating a welding contour 20a. According to embodiments of the invention, the welding contour 20a is traversed multiple times, in particular completely traversed multiple times. After or—preferably—during the traversal, an optical sensor 31 can be used to determine whether a further traversal is necessary. The optical sensor 31 is preferably arranged coaxially with the beam path of partial beams 8.

FIG. 9a and FIG. 9b are described together below. FIGS. 9a and 9b show an apparatus 30 according to embodiments of the invention with a welding optical unit 1 (in a development of the welding optical unit 1 from FIGS. 1a and 1b) for carrying out a method according to embodiments of the invention.

The apparatus 30 comprises a 2-in-1 fiber 2a for emitting an output laser beam 6. The output laser beam 6 passes through a collimation lens 3, which may comprise one lens or multiple lenses. The output laser beam 6 then passes through a dividing device 32 in order for the output laser beam 6 to be subdivided into multiple partial beams 8 and thus into multiple laser spots 12. The dividing device 32 may comprise at least one bifocal insert 4a, 4b, in particular multiple bifocal inserts 4a, 4b. As an alternative or in addition thereto, the dividing device 32 may comprise other optical elements, for example the facet plate 27 shown in FIGS. 6a and 6b.

Arranged downstream of the dividing device 32 is a scanner optical unit 33 which has at least one mirror 34a, 34b that can be pivoted in a controlled manner, in particular at least two mirrors 34a, 34b that can be pivoted in a controlled manner, in order to move the output laser beam 6 within a scanning field 35.

The scanner optical unit 33 is adjoined by a focusing lens 5, which may comprise one or more lenses.

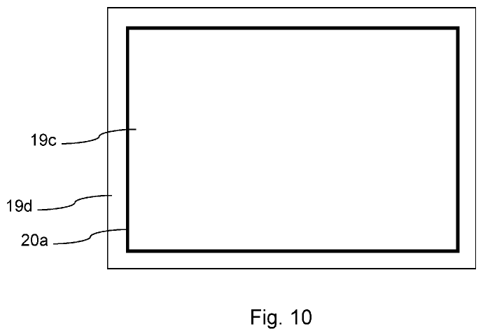

FIG. 10 shows welded components, a welding contour 20a having been created with a butt joint. Before the welding, a cover-like component 19c was inserted into the other vessel-like component 19d.

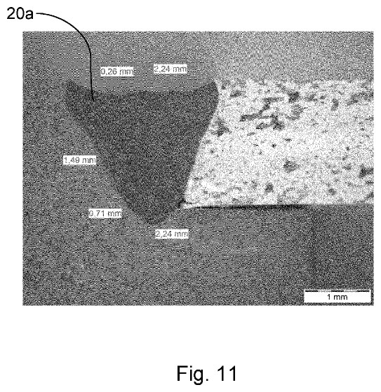

FIG. 11 shows a transverse microsection of two welded components, a twofold transversal being apparent from the welding contour 20a.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE DESIGNATIONS

1 Welding optical unit
2 Laser light cable
2a 2-in-1 fiber
3 Collimation lens
4a, 4b Bifocal inserts
5 Focusing lens
6 Output laser beam
7 Collimated laser beam
8 Partial beam
9 Core fiber
10 Ring fiber
11 Weld pattern
12 Laser spot
12′ Laser spot adjacent to laser spot 12″
12″ Laser spot adjacent to laser spot 12′
12′″ Central laser spot
12a Leading laser spot
12b Trailing laser spot
12c Middle laser spot
13 Core portion
14 Ring portion
15 Laser spot center
16 Ring formation
17 Common center
18 Feed direction
19 Component
19a Upper component
19b Lower component
19c Cover-like component
19d Vessel-like component
20 Surface
20a Welding contour
21 Vapor capillary
21a Projection
21b Recess
23 Lowermost point
24 Melt pool
24a Left-hand edge
24b Lower edge
24c Right-hand edge
25 Base plane
26 Central region
27 Facet plate
28 Central facet
29 Outer facets
30 Apparatus
31 Optical sensor
32 Dividing device
33 Scanner optical unit
34a, 34b Pivotable mirrors
35 Scanning field
β Facet angle
BD Component thickness
DK Diameter of core portion
Dᵤₚₚ Component thickness of upper component
DR Diameter of ring portion
D_{low} Component thickness of lower component
ET_{low} Welding depth into the bottom component
KFD Core fiber diameter
RFD Ring fiber diameter
Tₘₐₓ Maximum depth of the vapor capillary

1. A method for welding at least two aluminum-containing components, wherein the components each have a content of at least 75% by weight of aluminum, the method comprising:
subdividing an output laser beam into multiple partial beams directed onto the components, such that multiple laser spots are generated on a surface of the components, and
traversing a welding contour on the surface of the components with the multiple laser spots,
wherein laser spot centers of at least three laser spots of the multiple laser spots are arranged in a ring formation,
wherein the output laser beam is generated by a multifiber, such that each laser spot of the multiple laser spots on the surface of the components has a core portion and a ring portion, and
wherein the welding contour is at least partially traversed by pivoting a first mirror in a controlled manner by a scanner optical unit.

2. The method as claimed in claim 1, wherein, when the welding contour is being traversed, the scanner optical unit deflects the output laser beam by pivoting a second mirror in a controlled manner.

3. The method as claimed in claim 1, wherein the scanner optical unit deflects the output laser beam after the output laser beam has been collimated and before the output laser beam is focused.

4. The method as claimed in claim 1, wherein the output laser beam is subdivided into the multiple partial beams before the output laser beam is deflected by the scanner optical unit.

5. The method as claimed in claim 1, further comprising, after a first traversal of the welding contour, traversing the welding contour at least partially for a second time, the second traversal of the welding contour also being effected by the scanner optical unit.

6. The method as claimed in claim 5, wherein the second traversal is effected with a lower power and/or a lower feed speed than the first traversal.

7. The method as claimed in claim 5, further comprising capturing an image of the twice-traversed welding contour by an optical sensor and detecting defects based on the image, the image being captured during the second traversal of the welding contour.

8. The method as claimed in claim 5, further comprising, after the second traversal of the welding contour, traversing the welding contour at least partially for a third time, the third traversal of the welding contour also being effected by the scanner optical unit.

9. The method as claimed in claim 1, wherein one component of the at least two components comprises die-cast aluminum and/or a wrought aluminum alloy.

10. A component arrangement produced by welding at least two components by the method as claimed in claim 1,
wherein the component arrangement is impermeable to a medium at the welded welding contour.

11. An apparatus for welding at least two aluminum-containing components, the apparatus comprising:
a 2-in-1 fiber for emitting an output laser beam;
a dividing device for subdividing the output laser beam into multiple partial beams to be directed onto the components such that multiple laser spots are generated on a surface of the components, and wherein laser spot centers of at least three laser spots of the multiple laser spots are arranged in a ring formation, wherein each laser spot of the multiple laser spots on the surface of the components has a core portion and a ring portion;
a scanner optical unit comprising a first mirror that is capable of being pivoted in a controlled manner for traversing a welding contour on the surface of the components with the multiple laser spots.

12. The apparatus as claimed in claim 11, wherein the scanner optical unit comprises a second mirror that is capable of being pivoted in a controlled manner for traversing the welding contour.

13. The method as claimed in claim 1, wherein the multifiber comprises a 2-in-1 fiber.

14. The method as claimed in claim 1, wherein the welding is effected as deep penetration laser welding.
